(19) United States
(12) Patent Application Publication
(10) Pub. No.: US 2018/0325093 A1
(43) Pub. Date: Nov. 15, 2018

(54) PEST-MANAGEMENT ASSEMBLIES AND/OR COMPONENTS FOR PEST MANAGEMENT ASSEMBLIES

(71) Applicant: VM Products, Inc., Colleyville, TX (US)

(72) Inventors: Ethan VICKERY, Colleyville, TX (US); Eric SNELL, Colleyville, TX (US)

(21) Appl. No.: 15/973,947

(22) Filed: May 8, 2018

Related U.S. Application Data
(60) Provisional application No. 62/504,263, filed on May 10, 2017.

(51) Int. Cl. A01M 23/18

(52) U.S. Cl. CPC A01M 23/18

(57) ABSTRACT

This disclosure includes pest-management assemblies (e.g., capture stations, entrance assemblies, and combinations thereof), such as, for example, those that permit a rodent to enter and become trapped (e.g., via adhesive, a snap-trap, and/or being prevented from exiting the assemblies). For example, some embodiments of the present pest-management assemblies comprise a capture station and an entrance assembly comprising a door having a first end and a second end, an entranceway comprising a sidewall defining an opening through which a pest can enter the capture station, and a lip positioned such that it is interior to the capture station, where the lip of the entranceway has an upper edge disposed farther from a floor of the pest-management assembly than the second end of the door when the door is in the closed configuration, the lip positioned such that the lip does not obstruct the door from moving to the open configuration.

### CROSS-REFERENCE TO RELATED APPLICATIONS

This application claims priority to U.S. Provisional Application No. 62/504,263, filed May 10, 2017, the entire contents of which application is specifically incorporated by reference herein without disclaimer.

### FIELD OF INVENTION

The present invention relates generally to pest (e.g., rodent) management and, more specifically, but not by way of limitation, to pest-management assemblies and/or components for pest-management assemblies.

### BACKGROUND

Examples of pest-management assemblies are disclosed in: (1) U.S. Pat. No. 2,562,663; (2) U.S. Pat. No. 1,860,599; (3) U.S. Pat. No. 986,977; and (4) U.S. Pat. No. 270,753.

### SUMMARY OF THE INVENTION

This disclosure includes embodiments of pest-management assemblies and/or components for pest-management assemblies (e.g., capture stations, entrance assemblies and/or components for use in entrance assemblies, combinations thereof, and/or the like).

Some embodiments of the present pest-management assemblies comprise a capture station; and an entrance assembly comprising: a door having a first end and a second end; and an entranceway comprising: a sidewall defining an opening through which a pest can enter the capture station; and a lip positioned such that it is interior to the capture station; where the first end of the door is pivotally coupled to the entranceway such that the door is movable between: a closed configuration in which the door is positioned adjacent to the sidewall, and the door extends away from a floor of the pest-management assembly at an angle; and an open configuration; where the lip of the entranceway has an upper edge disposed farther from a floor of the pest-management assembly than the second end of the door when the door is in the closed configuration, the lip positioned such that the lip does not obstruct the door from moving to the open configuration.

In some embodiments of the present assemblies, the entrance assembly is coupled to the capture station. In some embodiments of the present assemblies, the entrance assembly is unitary with the capture station. In some embodiments of the present assemblies, the door is unitary with the entranceway.

In some embodiments of the present assemblies, the capture station comprises an elongated tunnel sized to accommodate a pest.

In some embodiments of the present assemblies, the entrance assembly is a first entrance assembly, and the pest-management assembly further comprises a second entrance assembly comprising: a door having a first end and a second end; and an entranceway comprising: a sidewall defining an opening through which a pest can enter the capture station; and a lip positioned such that it is interior to the capture station; where the first end of the door is pivotally coupled to the entranceway such that the door is movable between: a closed configuration in which the door is positioned adjacent to the sidewall, and the door extends away from a floor of the pest-management assembly at an angle; and an open configuration; where the lip of the second entrance assembly has an upper edge disposed farther from a floor of the pest-management assembly than the second end of the door when the door is in the closed configuration, the lip positioned such that the lip does not obstruct the door from moving to the open configuration.

In some embodiments of the present assemblies, the second entrance assembly is coupled to the capture station. In some embodiments of the present assemblies, the second entrance assembly is unitary with the capture station.

In some embodiments of the present assemblies, the capture station comprises a lid configured to be coupled to a base such that the base and the lid cooperate to define a chamber, where at least one of the base and the lid comprises a sidewall at least partially defining an external perimeter of the assembly; where at least one of the base, the lid, and the sidewall is configured to be coupled to the entrance assembly.

In some embodiments of the present assemblies, the lip of entranceway is configured to prevent a pest in the capture station from engaging the second end of the door. In some embodiments of the present assemblies, the lip of the first entrance assembly is configured to prevent a pest in the capture station from engaging the second end of the door of the first entrance assembly, and the lip of the second entrance assembly is configured to prevent a pest in the capture station from engaging the second end of the door of the second entrance assembly.

In some embodiments of the present assemblies, the angle at which a door extends away from a floor of the pest-management assembly comprises from 40 to 50 degrees. In some embodiments of the present assemblies, the angle at which a door extends away from a floor of the pest-management assembly comprises approximately 45 degrees.

In some embodiments of the present assemblies, a floor of the pest-management assembly is a surface on which the pest-management assembly is disposed. In some embodiments of the present assemblies, the capture station further comprises a base, and a floor of the pest-management assembly is the base of the capture station.

In some embodiments of the present assemblies, the sidewall comprises: a first side and a second side through which a pest can enter the capture station, where a portion of the first side and a portion of the second side extend away from a floor of the pest-management assembly at an angle, and where the door is positioned adjacent to the portion of the first side and the portion of the second side that extend away from a floor of the pest-management assembly at an angle such that the door extends away from a floor of the pest-management assembly at substantially the same angle.

Some embodiments of the present pest-management assemblies comprise a base; and a lid configured to be coupled to the base such that the base and the lid cooperate to define a chamber, where at least one of the base and the lid comprises a sidewall at least partially defining an external perimeter of the assembly; where at least one of the base, the lid, and the sidewall is configured to be coupled to an entrance assembly that comprises: a door having a first end and a second end; and an entranceway comprising: a sidewall defining an opening through which a pest can enter the chamber; and a lip positioned such that it is interior to the chamber, if the entrance assembly is coupled to at least one of the base, the lid, and the sidewall; where the first end of the door is pivotally coupled to the entranceway such that the door is movable between: a closed configuration in which the door is positioned adjacent to the sidewall, and the door extends away from the base at an angle; and an open configuration; where the lip of the entranceway has an upper edge disposed farther from the base of the pest-management assembly than the second end of the door when the door is in the closed configuration, the lip positioned such that the lip does not obstruct the door from moving to the open configuration.

Some embodiments of the present assemblies comprise an entrance assembly coupled to at least one of the base, the lid, and the sidewall, where the entrance assembly comprises: a door having a first end and a second end; and an entranceway comprising: a sidewall defining an opening through which a pest can enter the chamber; and a lip positioned such that it is interior to the chamber; where the first end of the door is pivotally coupled to the entranceway such that the door is movable between: a closed configuration in which the door is positioned adjacent to the sidewall, and the door extends away from the base at an angle; and an open configuration; where the lip of the entranceway has an upper edge disposed farther from the base of the pest-management assembly than the second end of the door when the door is in the closed configuration, the lip positioned such that the lip does not obstruct the door from moving to the open configuration.

In some embodiments of the present assemblies, at least one of the base, the lid, and the sidewall is further configured to be coupled to another entrance assembly that comprises: a door having a first end and a second end; and an entranceway comprising: a sidewall defining an opening through which a pest can enter the chamber; and a lip positioned such that it is interior to the chamber, if the another entrance assembly is coupled to at least one of the base, the lid, and the sidewall; where the first end of the door is pivotally coupled to the entranceway such that the door is movable between: a closed configuration in which the door is positioned adjacent to the sidewall, and the door extends away from the base at an angle; and an open configuration; where the lip of the entranceway has an upper edge disposed farther from the base of the pest-management assembly than the second end of the door when the door is in the closed configuration, the lip positioned such that the lip does not obstruct the door from moving to the open configuration.

In some embodiments of the present assemblies, the entrance assembly is a first entrance assembly, and the pest-management assembly further comprises: a second entrance assembly coupled to at least one of the base, the lid, and the sidewall, where the second entrance assembly comprises: a door having a first end and a second end; and an entranceway comprising: a sidewall defining an opening through which a pest can enter the chamber; and a lip positioned such that it is interior to the chamber; where the first end of the door is pivotally coupled to the entranceway such that the door is movable between: a closed configuration in which the door is positioned adjacent to the sidewall, and the door extends away from the base at an angle; and an open configuration; where the lip of the entranceway has an upper edge disposed farther from the base of the pest-management assembly than the second end of the door when the door is in the closed configuration, the lip positioned such that the lip does not obstruct the door from moving to the open configuration

In some embodiments of the present assemblies, the lip of the entranceway is configured to prevent a pest in the chamber from engaging the second end of the door. In some embodiments of the present assemblies, the lip of the first entrance assembly is configured to prevent a pest in the chamber from engaging the second end of the door of the first entrance assembly, and the lip of the second entrance assembly is configured to prevent a pest in the chamber from engaging the second end of the door of the second entrance assembly.

In some embodiments of the present assemblies, the angle at which a door extends away from the base comprises from 40 to 50 degrees. In some embodiments of the present assemblies, the angle at which a door extends away from the base comprises approximately 45 degrees.

In some embodiments of the present assemblies, the sidewall comprises: a first side and a second side through which a pest can enter the chamber, where a portion of the first side and a portion of the second side extend away from the base of the pest-management assembly at an angle, and where the door is positioned adjacent to the portion of the first side and the portion of the second side that extend away from the base of the pest-management assembly at an angle such that the door extends away from the base of the pest-management assembly at substantially the same angle.

Some embodiments of the present entrance assemblies (e.g., configured to be coupled to a capture station) comprise: a door having a first end and a second end; and an entranceway comprising: a sidewall through which a pest can move; and a lip positioned such that it is interior to a capture station, if the entrance assembly is coupled to a capture station; where the first end of the door is configured to be pivotally coupled to the entranceway such that the door is movable between: a closed configuration in which the door is positioned adjacent to the sidewall, and the door extends away from a floor of a capture station at an angle, if the entrance assembly is coupled to a capture station; and an open configuration; where the lip of the entranceway has an upper edge disposed farther from a floor of the capture station than the second end of the door when the door is in the closed configuration, if the entrance assembly is coupled to a capture station, the lip positioned such that the lip does not obstruct the door from moving to the open configuration.

In some embodiments of the present assemblies, the entrance assembly is coupled to a capture station. In some embodiments of the present assemblies, the entrance assembly is unitary with a capture station.

In some embodiments of the present assemblies, the capture station comprises an elongated tunnel sized to accommodate a pest.

In some embodiments of the present assemblies, the capture station comprises: a lid configured to be coupled to a base such that the base and the lid cooperate to define a chamber, where at least one of the base and the lid comprises a sidewall at least partially defining an external perimeter of the assembly; where at least one of the base, the lid, and the sidewall is coupled to the entrance assembly.

In some embodiments of the present assemblies, the lip of the entranceway is configured to prevent a pest in a capture station from engaging the second end of the door, if the entrance assembly is coupled to a capture station.

In some embodiments of the present assemblies, the angle at which the door extends away from a floor of a capture station comprises from 40 to 50 degrees. In some embodiments of the present assemblies, the angle at which the door extends away from a floor of a capture station comprises approximately 45 degrees. In some embodiments of the present assemblies, the first end of the door is pivotally coupled to the entranceway.

In some embodiments of the present assemblies, the sidewall comprises: a first side and a second side, where a portion of the first side and a portion of the second side extend away from a floor of a capture station, if the entrance assembly is coupled to a capture station, where the door is positioned adjacent to the portion of the first side and the portion of the second side that extend away from a floor of a capture station at an angle such that the door extends away from a floor of the capture station at substantially the same angle.

The term “coupled” is defined as connected, although not necessarily directly, and not necessarily mechanically; two items that are “coupled” may be unitary with each other. The terms “a” and “an” are defined as one or more unless this disclosure explicitly requires otherwise. The term “substantially” is defined as largely but not necessarily wholly what is specified (and includes what is specified; e.g., substantially 90 degrees includes 90 degrees and substantially parallel includes parallel), as understood by a person of ordinary skill in the art. In any disclosed embodiment, the terms “substantially” and “approximately” may be substituted with “within [a percentage] of” what is specified, where the percentage includes 0.1, 1, 5, and 10 percent.

Further, an apparatus or system that is configured in a certain way is configured in at least that way, but it can also be configured in other ways than those specifically described.

The terms “comprise” (and any form of comprise, such as “comprises” and “comprising”), “have” (and any form of have, such as “has” and “having”), and “include” (and any form of include, such as “includes” and “including”) are open-ended linking verbs. As a result, an apparatus that “comprises,” “has,” or “includes” one or more elements possesses those one or more elements, but is not limited to possessing only those elements. Likewise, a method that “comprises,” “has,” or “includes” one or more steps possesses those one or more steps, but is not limited to possessing only those one or more steps.

Any embodiment of any of the apparatuses can consist of or consist essentially of—rather than comprise/include/have—any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb.

The feature or features of one embodiment may be applied to other embodiments, even though not described or illustrated, unless expressly prohibited by this disclosure or the nature of the embodiments.

Some details associated with the embodiments are described above and others are described below.

### BRIEF DESCRIPTION OF THE DRAWINGS

The following drawings illustrate by way of example and not limitation. For the sake of brevity and clarity, every feature of a given structure is not always labeled in every figure in which that structure appears. Identical reference numbers do not necessarily indicate an identical structure. Rather, the same reference number may be used to indicate a similar feature or a feature with similar functionality, as may non-identical reference numbers. The figures are drawn to scale (unless otherwise noted), meaning the sizes of the depicted elements are accurate relative to each other for at least the embodiment depicted in the figures.

FIG. 1A is a perspective view of a first embodiment of the present pest-management assemblies.

FIGS. 1B-1E are side, top, perspective, and bottom views, respectively, of the pest-management assembly of FIG. 1A.

FIG. 2A is top view of a capture station, which may be suitable for use in some embodiments of the present pest-management assemblies.

FIGS. 2B and 2C are perspective and bottom views, respectively, of the capture station of FIG. 2A.

FIG. 3A is a perspective view of an entrance assembly, which may be suitable for use in some embodiments of the present pest-management assemblies, shown coupled to a capture station.

FIG. 3B is a side view of the entrance assembly of FIG. 3A.

FIGS. 3C-3F are perspective views of the entrance assembly of FIG. 3A.

FIG. 4A is a side view of an entrance way, which may be suitable for use in some embodiments of the present pest-management assemblies.

FIGS. 4B-4D are perspective views of the entrance way of FIG. 4A.

FIG. 5A is a perspective view of a door, which may be suitable for use in some embodiments of the present pest-management assemblies.

FIG. 5B is a perspective view of the door of FIG. 5A.

FIG. 6 is a top view of a second embodiment of the present pest-management assemblies.

### DETAILED DESCRIPTION OF ILLUSTRATIVE EMBODIMENTS

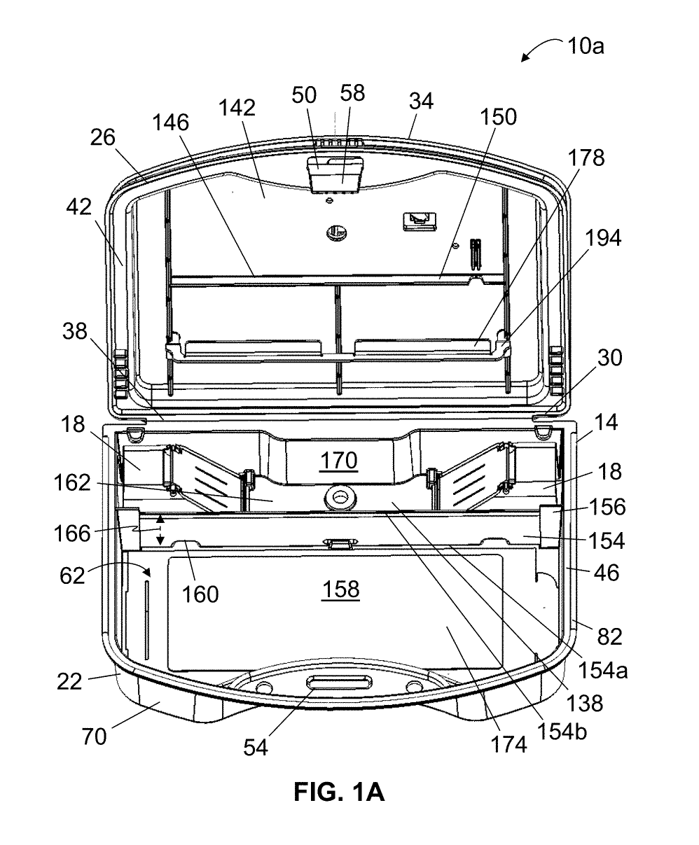

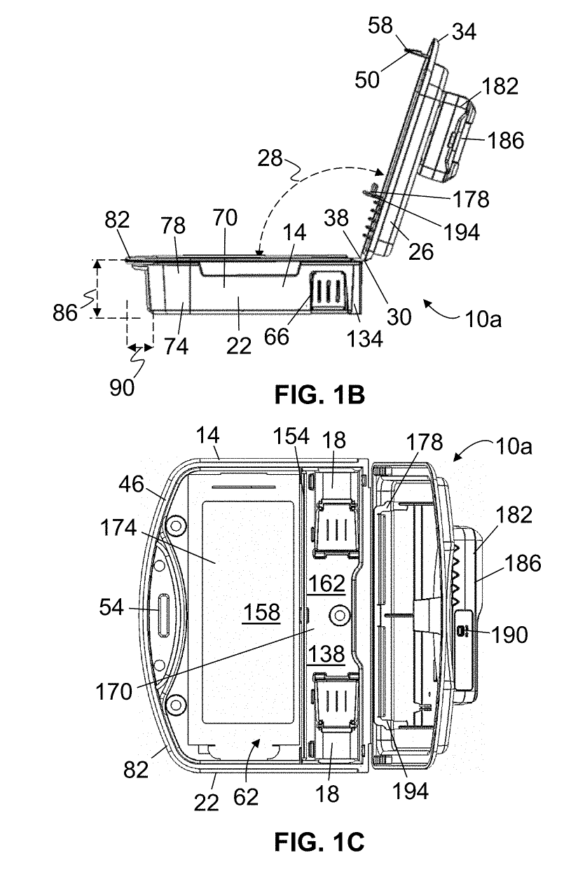

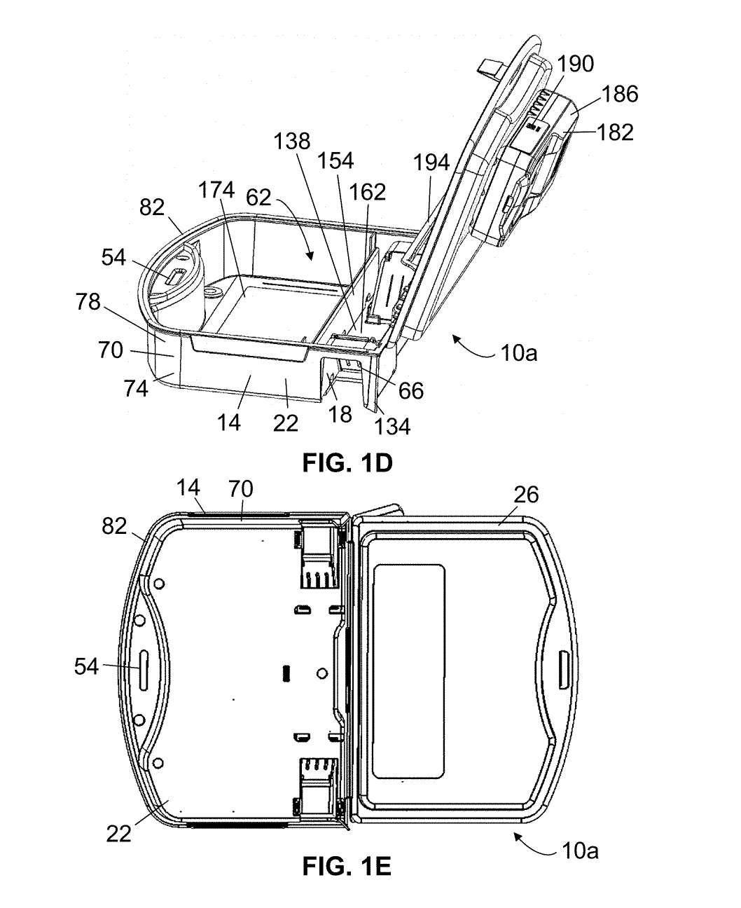

Referring now to the figures, and more particularly to FIGS. 1A-1E, shown therein and designated by the reference numeral 10a is a first embodiment of the present pest-management assemblies. In the embodiment shown, and as described in more detail below, assembly 10a comprises a capture station (e.g., 14) and an entrance assembly (e.g., 18) (e.g., first and second entrance assemblies 18) configured to permit rodent ingress into the capture station, but prevent rodent egress from the capture station.

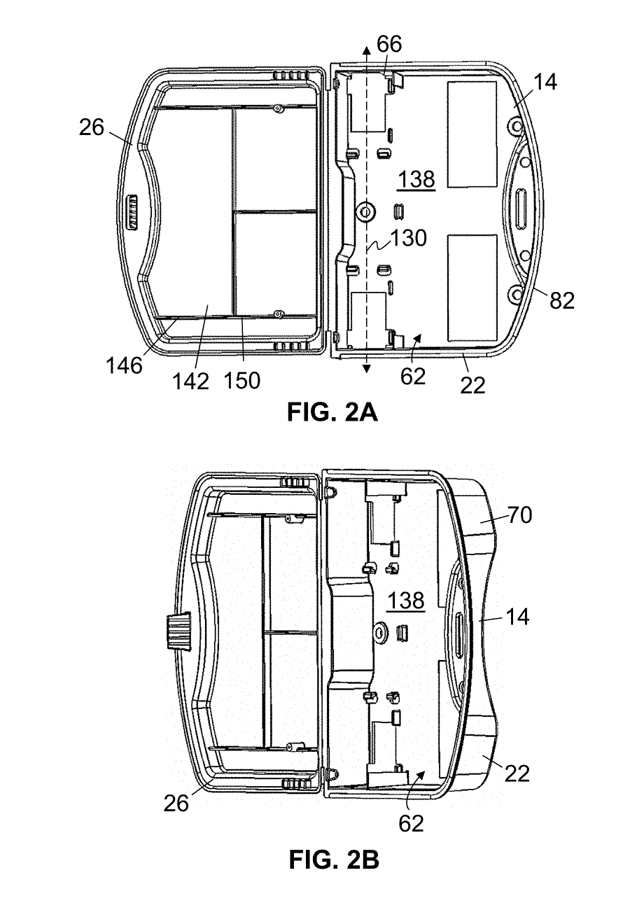

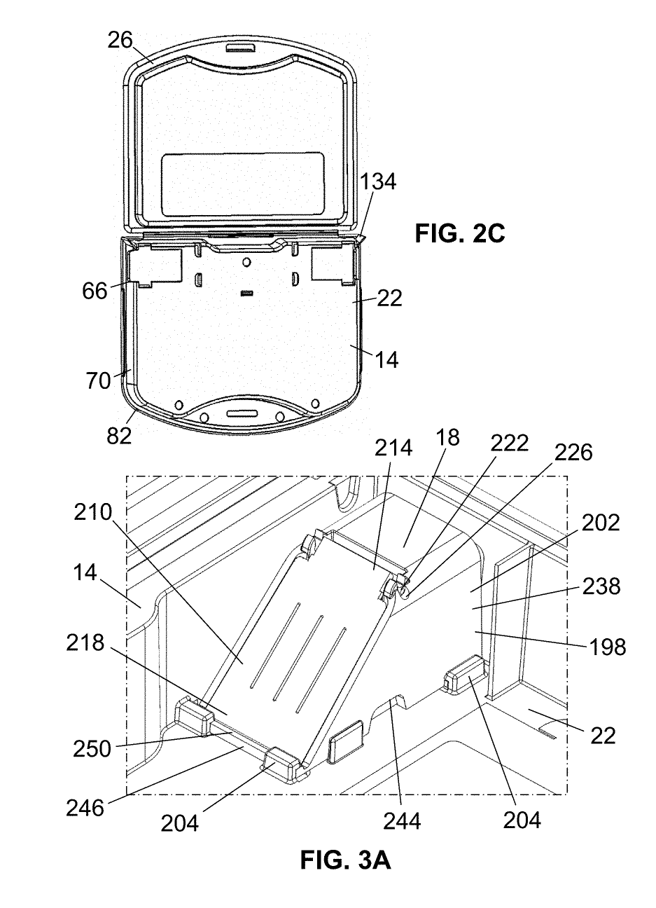

Referring additionally to FIGS. 2A-2C, shown are various views of a capture station 14, which may be suitable for use in some embodiments of the present pest-management assemblies. In this embodiment, capture station 14 comprises a base 22 and a lid 26 configured to be coupled to (e.g., is shown coupled to) the base, the lid movable (e.g., generally along a direction indicated by arrow 28, FIG. 1B) relative to the base between an opened position (e.g., as shown) and a closed position. For example, in the depicted embodiment, lid 26 has a first end or edge 30 and a second end or edge 34, and one of first end or edge 30 and second end or edge 34 (e.g., first end or edge 30, in the embodiment shown) is pivotally coupled to base 22, for example, via a hinge 38. In this embodiment, lid 26 is unitary and/or integrally formed with base 22 (e.g., the base and the lid comprise a single piece of material such that hinge 38 is a living hinge). However, in other embodiments of the present assemblies, a respective capture station (e.g., 14) may have a lid (e.g., 26) that is coupled to a base (e.g., 22) in any suitable fashion, such as, for example, slidably coupled to the base, detachably coupled to the base, and/or the like. In the depicted embodiment, lid 26 defines a peripheral recess 42 configured to receive a corresponding peripheral ridge 46 of base 22 when the lid is in the closed position (e.g., such that the peripheral recess and peripheral ridge cooperate to resist separation of the lid and the base).

In the embodiment shown, capture station 14 comprises a latch 50 (e.g., including a latching protrusion 58 and an opening 54) configured to resist separation of lid 26 and base 22 when the lid is in the closed position. For example, in this embodiment, lid 26 comprises a latching protrusion 58, and base 22 defines an opening 54 configured to receive and retain at least a portion of the latching protrusion when the lid is in the closed position. In the depicted embodiment, capture station 14 is configured to permit a user to release lid 26 relative to base 22 when the lid is in the closed position such that the lid can be moved from the closed position to the opened position. For example, in the embodiment shown, at least a portion of latching protrusion 58 is accessible from an exterior of capture station 14 when the latching protrusion is received and retained by opening 54 (e.g., the opening is in communication with an exterior of the capture station when lid 26 is in the closed position) such that a user may depress the accessible portion of the latching protrusion to release the latching protrusion from the opening and thus the lid relative to base 22.

In this embodiment, base 22 and lid 26 cooperate to define (e.g., when the lid is in the closed position) a chamber 62. In the depicted embodiment, capture station 14 defines an entrance opening 66 (e.g., two entrance openings 66, as shown) in communication with chamber 62 and configured (e.g., sized) to permit a rodent to enter capture station 14 (e.g., into chamber 62). In the embodiment shown, entrance opening 66 is defined solely by base 22 (e.g., lid 26 defines no portion of a perimeter of the entrance opening); however, in other embodiments of the present assemblies, entrance opening(s) (e.g., 66) of a respective capture station (e.g., 14) may be defined solely by a lid (e.g., 26) or defined cooperatively by a base (e.g., 22) and the lid (e.g., when the lid is in the closed position). In this embodiment, entrance opening 66 is defined by base 22 such that a portion of (e.g., up to and including a majority of) the perimeter of the entrance opening is defined by a floor 138 (described in more detail below) of the base. In at least this way, entrance opening 66 may be configured to avoid discouraging a rodent from entering the entrance opening (e.g., a rodent may step through at least a portion of the entrance opening without stepping over other portions of base 22).

In the depicted embodiment, at least one of base 22 and lid 26 (e.g., base 22, in the embodiment shown) comprises a sidewall 70 having a lower portion 74 and an upper portion 78, the sidewall at least partially defining an external perimeter of capture station 14. In this embodiment, sidewall 70 is configured to discourage a rodent (e.g., at or near the sidewall) from climbing onto lid 26. For example, in the depicted embodiment, sidewall 70 defines a lip 82 (e.g., at or near upper portion 78) that extends away from chamber 62. In the embodiment shown, lip 82 extends a lateral distance 90 measured from lower portion 74 of sidewall 70, and the sidewall extends a height 86 between the lower portion and upper portion 78 (FIG. 1B). In this embodiment, distance 90 is at least 20 percent of height 86 (e.g., 25, 30, 35, 40, 35, 40, 45 or more percent of the height).

In the depicted embodiment, capture station 14 may be characterized as having a front side (e.g., a side nearest opening 54 of latch 50), a back side opposite the front side (e.g., a side nearest hinge 38), and opposing left and right sides, each extending between the front side and the back side. In the embodiment shown, the left and right sides of capture station 14 each have a shape or profile that is substantially similar to the other of the left and right sides (e.g., the left and right sides may be both substantially similar to one another and mirrored, such that, for example, the left and right sides are substantially symmetrical about a plane that transects the capture station). For example, in this embodiment, the left and right sides each define an entrance opening 66 (e.g., such that the entrance opening defined by the left side is defined on an opposite side of capture station 14 from the entrance opening defined by the right side). For further example, in the depicted embodiment, an axis 130 that is parallel to a floor 138 (described in more detail below) of capture station 14 may extend through each of an entrance opening 66 defined by the left side of the capture station and an entrance opening 66 defined by the right side of the capture station (FIG. 2A). However, in other embodiments of the present assemblies, entrance opening(s) (e.g., 66) of a respective capture station (e.g., 14) may be defined by the capture station at any suitable location (e.g., defined on a front side, a back side, a left side, a right side, and/or the like of the respective capture station).

In the embodiment shown, the back side of capture station 14 is configured to minimize lateral access to a space between the back side and a substantially vertical surface (e.g., a wall) when the capture station is disposed with the back side adjacent to the substantially vertical surface. For example, in this embodiment, the back side of capture station 14, and more particularly, of base 22, comprises one or more protrusions 134, each extending from sidewall 70 and away from chamber 62 and configured to block or substantially block lateral access to a space between the back side and a substantially vertical surface when the capture station is disposed with the back side adjacent to the substantially vertical surface. Of course, other embodiments of the present assemblies may include a respective capture station (e.g., 14) having a front side, back side, left side, right side, and/or the like having any suitable shape or profile.

In the depicted embodiment, base 22 comprises a floor 138. In the embodiment shown, floor 138 is unitary and/or integrally formed with sidewall 70 of base 22; however, other embodiments of the present assemblies may include a respective capture station (e.g., 14) having a base (e.g., 22) with a floor (e.g., 138) that is detachably coupled (e.g., via latches) to a sidewall (e.g., 70) of the base. In some embodiments, a floor (e.g., 138) may be configured to prevent movement of a base (e.g., 22) of a respective capture station (e.g., 14) relative to a surface on which the base is disposed. For example, in such embodiments, an exterior surface (e.g., an outermost surface) of the floor may be textured and/or may include a non-slip material, such as, for example, a rubber or an adhesive. In some embodiments of the present assemblies, a floor (e.g., 138) may comprise a surface on which a base (e.g., 22) of a respective capture station (e.g., 14) is placed or disposed (e.g., during use of the assemblies), and, in some such embodiments, the base may not comprise a floor.

In this embodiment, lid 26 comprises a substantially planar portion 142 and a reinforcing portion 146 (e.g., configured to increase a stiffness of the lid). For example, in the depicted embodiment, reinforcing portion 146 of lid 26 comprises one or more ribs 150 (e.g., which may be unitary and/or integrally formed with the lid). However, other embodiments of the present assemblies may comprise a respective capture station (e.g., 14) having a lid (e.g., 26) with a reinforcing portion (e.g., 146) that comprises any suitable structure, such as, for example, one or more rods, a mesh, and/or the like, and any suitable material, such as, for example, plastic, steel, aluminum, wood, and/or the like. In the embodiment shown, reinforcing portion 146 of lid 26 is disposed on the lid such that, when the lid is in the closed position, the reinforcing portion is interior to capture station 14 (e.g., extends into chamber 62); however, in other embodiments, a reinforcing portion (e.g., 146) of a lid (e.g., 26) of a respective capture station (e.g., 14) may be disposed on the lid such that, when the lid is in the closed position, the reinforcing portion is exterior to the respective capture station 14.

In this embodiment, capture station 14 (e.g., at least one of base 22 and lid 26) comprises plastic, such as, for example, polypropylene (PP), polystyrene (PS), high impact polystyrene (HIPS), acrylonitrile butadiene styrene (ABS), polyethylene terephthalate (PET), polyvinyl chloride (PVC), polycarbonate (PC), polyethylene (PE), polycarbonate/acrylonitrile butadiene styrene (PC/ABS), polycarbonate polybutylene terephthalate (PBT), acrylonitrile styrene acrylate (ASA), a polyurethane, nylon (often referred to as polyamide (PA)), another plastic or polymer, and/or the like. However, in other embodiments of the present assemblies, a respective capture station (e.g., 14) (e.g., at least one of a base 22 and a lid 26) may comprise any suitable material, including non-plastic materials, such as, for example, a metal (e.g., steel, iron, aluminum, copper, brass, and/or the like), fiberglass, carbon fiber, a synthetic material, and/or the like.

In the depicted embodiment, assembly 10a comprises a separator 154 configured to be coupled to capture station 14 such that if lid 26 is in the closed position relative to base 22 to define chamber 62, the separator divides the chamber into a rodent capture portion 158 and a rodent entry portion 162. In the embodiment shown, separator 154 is removably coupled to at least one of lid 26 and base 22. For example, in this embodiment, separator 154 extends between vertically-oriented grooves 156 (FIG. 1A) defined in the interior of base 22 such that the separator can be removed and/or re-inserted (e.g., for replacement) by sliding the separator. In other embodiments, a separator (e.g., 154) can be unitary with a base (e.g., 22) of a respective capture station (e.g., 14), or a separator can be unitary with a lid (e.g., 26) of a respective capture station (e.g., 14) (e.g., such that the separator extends downward from the lid, extends into a chamber 62 when the lid is closed relative to a base 14 of the respective capture station, and is removed from the chamber when the lid is opened relative to the base).

In the depicted embodiment, separator 154 is substantially planar; however, in other embodiments of the present assemblies, respective separators (e.g., 154) may comprise any shape that permits the functionality of this disclosure. In the embodiment shown, separator 154 is configured to be coupled to capture station 14 such that the separator is substantially perpendicular to floor 138 of base 22; however, in other embodiments of the present assemblies, a respective separator (e.g., 154) may be configured to be coupled to a respective capture station (e.g., 14) such that the respective separator is oriented at any suitable angle, such as, for example, 90 degrees, 60 degrees, 45 degrees, or smaller, relative to a floor (e.g., 138) of a base (e.g., 22) of the respective capture station.

In the embodiment shown, entry portion 162 and capture portion 158 are in fluid communication when lid 26 is in the closed position (e.g., when separator 154 is coupled to capture station 14). For example, in this embodiment, separator 154 has a height 166 (FIG. 1A) that is smaller than a longitudinal distance from floor 138 to lid 26 when the lid is in the closed position. In this way, separator 154 and at least one of floor 138 and lid 26 may cooperate to define a space through which a rodent may pass from entry portion 162 to capture portion 158 when the lid is in the closed position. More particularly, in the depicted embodiment, separator 154 is configured to prevent a rodent from accessing at least a portion of chamber 62 (e.g., rodent capture portion 158) except by climbing over the separator. For example, in the embodiment shown, separator 154 comprises an elongated member having a planar configuration with a lower edge 154a that is spaced from floor 138 by a distance that is small enough to prevent a rodent from passing under separator. For example, in this embodiment, lower edge 154a of separator 154 is in contact with floor 138 when the separator is coupled to capture station 14 (e.g., with discrete openings 160 at or above the lower edge to permit insects to crawl under or through the separator). In other embodiments, a lower edge (e.g., 154a) of a respective separator (e.g., 154) may be spaced from a floor (e.g., 138) by a distance of less than any one of, or between any two of: 0.10, 0.15, 0.20, 0.25, 0.30, 0.35, 0.40, 0.45, and/or 0.50 inches. In the depicted embodiment, an upper edge 154b of separator 154 is disposed at a distance of between 1.00 and 1.25 inches from floor 138 when the separator is coupled to capture station 14. In other embodiments, an upper edge (e.g., 154b) of a respective separator (e.g., 154) may be disposed at any distance from a floor (e.g., 138) (e.g., between 0.75 and 1.50 inches for mice, or a greater distance for rats, which are generally larger than mice) that requires a rodent of expected size to have to climb over the respective separator to traverse from an entry portion (e.g., 162) to a capture portion (e.g., 158). In the embodiment shown, when separator 154 is coupled to capture station 14 and lid 26 is closed relative to base 22, upper boundary 154b is spaced from a bottom surface of the lid by a distance of between 0.8 and 0.9 inches. In other embodiments, a distance between a lid (e.g., 26) of a respective capture station (e.g., 14) and an upper boundary (e.g., 154b) of a respective separator (e.g., 154) can be any suitable distance that permits a targeted rodent species (e.g., a mouse or rat) to climb over the respective separator (e.g., such that it is easier for the rodent to climb over, rather than crawl under, the respective separator) (e.g., a distance greater than any one of, or between any two of: 0.25, 0.50, 0.75, and/or 1.00 inch).

In this embodiment, assembly 10a, and more particularly, entry portion 162 of chamber 62, comprises an elongated tunnel 170 sized to accommodate a pest. In the depicted embodiment, capture portion 158 of chamber 62 may be configured to (e.g., and/or may contain components that are configured to) resist a rodent's exit from assembly 10a. For example, in the embodiment shown, assembly 10a comprises a glue or adhesive disposable within capture portion 158, for example, disposed on a glue or adhesive board 174 that is disposable within the capture portion. In this embodiment, forcing a rodent to climb over separator 154 may increase the likelihood of the rodent making sufficient contact with adhesive board 174 to be captured. For example, absent separator 154, a rodent can place a single foot on adhesive board 174 in capture portion 158 and may be able to withdraw the single foot upon realizing that adhesive is present. In contrast, in the depicted embodiment, a rodent is forced to commit to entering capture portion 158 by climbing over separator 154, thereby increasing the likelihood that at least two of the rodent's feet will contact adhesive board 174, and the rodent will be captured and prevented from escaping. Of course, other embodiments of the present assemblies may comprise any suitable respective rodent capture means (e.g., snap trap(s), bait, poison, and/or the like, which may be disposable within a capture portion 158).

In some embodiments, a respective separator (e.g., 154) may include a reflective surface. For example, for a respective separator having a planar configuration, such as separator 154, a side of the respective separator that faces an entry portion 162 can be reflective (e.g., can be covered with a reflective paint, reflective tape, and/or the like). In some embodiments, a respective separator (e.g., 154) may comprise a translucent or transparent material to allow a rodent to partially and/or entirely see through at least part of the respective separator, to, for example, minimize a rodent's reluctance to climb over the respective separator.

In some embodiments, one or more wires may be used in addition to or in lieu of a respective separator (e.g., 154). For example, in some embodiments, an upper wire may be positioned in a respective capture station (e.g., 14) in a same or similar location as upper edge 154b of separator 154 within capture station 14, and a lower wire may be positioned in a same or similar location as lower edge 154a of separator 154 within capture station 14.

For a more detailed description of separators that may be suitable for use in some embodiments of the present pest-management assemblies, including the structure of such separators and/or the relative placement of such separators within a capture station and/or pest-management assembly, see International Application No. PCT/US2014/066824, filed on Nov. 21, 2014 and entitled “PEST-MANAGEMENT APPARATUSES WITH SEPARATOR TO DIRECT RODENT MOVEMENT AND/OR IMPROVE RODENT CONTACT WITH ADHESIVE,” which is expressly incorporated by reference in its entirety, and more specifically, ¶¶ [0040]-[0046], [0052], and [0053], and FIGS. 1, 2, and 10.

In the depicted embodiment, assembly 10a comprises a sensor 178 configured to detect a presence of a rodent (e.g., passing from entry portion 162 to capture portion 158, for example, over separator 154). The following description of sensor 178 is provided only by way of example, as embodiments of the present assemblies may comprise any suitable respective sensor (e.g., 178), such as, for example, an optical sensor (e.g., a laser- and/or infrared-based sensor, and/or the like), a contact sensor (e.g., a pressure sensor, pressure-sensitive switch, and/or the like), a proximity sensor (e.g., a capacitive sensor, magnetic sensor, ultrasonic sensor, and/or the like), and/or the like.

For example, in the embodiment shown, sensor 178 comprises a capacitive sensor (e.g., the sensor is configured to detect the presence of a rodent by measuring changes in an electric field caused by the presence of the rodent). Generally speaking, in these and similar embodiments, one or more electrodes (described in more detail below) may be used to generate an electric field, an object, such as a rodent, interacting with the electric field may cause changes in the electric field, and such changes in the electric field may be detected to indicate the presence of the object. Respective capacitive sensors (e.g., 178) of some embodiments of the present assemblies may be self-capacitive (e.g., configured to detect a change in a capacitive load on one or more electrodes caused by the presence of an object), or mutual-capacitive (e.g., configured to detect a change in a capacitance between two or more electrodes caused by the presence of an object).

More specifically, in this embodiment, sensor 178 includes a control module 182 that may be configured to generate an electric field and/or monitor for changes in an electric field. In the depicted embodiment, control module 182 comprises a housing 186, which, in some embodiments, may protect certain components of sensor 178 and/or control module 182 from an external environment. In the embodiment shown, control module 182 and/or sensor 178 may be battery powered (e.g., by one or more batteries, which may be disposed within housing 186); however, in other embodiments of the present assemblies, a respective control module (e.g., 182) and/or a respective sensor (e.g., 178) may be powered by an external (e.g., to assembly 10a) power source. In this embodiment, control module 182 comprises a switch 190 configured to selectively activate or deactivate control module 182 and/or sensor 178 (e.g., to preserve battery life).

In the embodiment shown, sensor 178 is configured to detect a rodent climbing over separator 154. For example, in this embodiment, assembly 10a comprises an electrically-conductive member 194 configured to be coupled to at least one of lid 26 and base 22 such that the electrically-conductive member is disposed at or above at least a portion of (e.g., an upper edge of) separator 154 when the lid is in the closed position. In the depicted embodiment, electrically-conductive member 194 is configured to extend along (e.g., over) a majority of separator 154 without substantially blocking communication between entry portion 162 and capture portion 158 through or past the separator when lid 26 is in the closed position. In these ways and others, electrically-conductive member 194 is located such that a rodent climbing over or passing under separator 154 may contact or pass above or below the electrically-conductive member (e.g., between the electrically-conductive member and lid 26), but such that the electrically-conductive member does not substantially hinder the ability of the rodent to climb over or pass under the separator. In other embodiments, an electrically-conductive member (e.g., 194) may be unitary with a respective separator (e.g., 154), and/or a respective separator (e.g., 154) may comprise an electrically-conductive material (e.g., such that the respective separator performs a same or similar function to electrically-conductive member 194 and the electrically-conductive member may be omitted).

Electrically-conductive member 194, in the embodiment shown, may function as an electrode (e.g., as an electrode of a mutual- or self-capacitive sensor). For example, in this embodiment, sensor 178 comprises a mutual-capacitive sensor. By way of illustration, in the depicted embodiment, sensor 178 and/or control module 182 may supply an electrical (e.g., alternating current (AC)) signal to a drive electrode (e.g., an electrically-conductive member that may be disposed within housing 186, lid 26, base 22, and/or the like). Due, at least in part, to capacitive coupling, a responsive signal may be generated within a sense electrode, such as, for example, electrically-conductive member 194. In these and similar embodiments, such a responsive signal may be monitored (e.g., by sensor 178 and/or by control module 182) to detect changes in the responsive signal (e.g., to indicate the presence of an object, such as a rodent).

In some embodiments of the present assemblies, a respective sensor (e.g., 178) may comprise a self-capacitive sensor. By way of illustration, in some such embodiments, a respective sensor (e.g., 178) and/or a respective control module (e.g., 182) may supply an electrical (e.g., steady-state AC) signal to an electrode, such as an electrically-conductive member (e.g., 194). In such embodiments, the capacitive load on the electrode may change when an object, such as a rodent, nears the electrode. In such embodiments, changes in capacitive load on the electrode may be monitored (e.g., by a respective sensor 178 and/or a respective control module 182) to detect the presence of the object.

In some embodiments of the present assemblies, when a respective sensor (e.g., 178) and/or a respective control module (e.g., 182) detects the presence of an object, such as a rodent, within a portion of a respective capture station (e.g., 14), a signal, alert, alarm, and/or the like may be communicated (e.g., an audible signal, a signal communicated via a wired and/or wireless communications device, and/or the like). Some embodiments of the present assemblies (e.g., via a respective sensor 178 and/or control module 182) may be configured to send and/or relay signals (e.g., via a respective transceiver) indicative of an object detection within the assembly (e.g., within a portion of a respective capture station 14) and/or within other assembl(ies) (e.g., to form part of a system). Examples of systems with which some embodiments of the present assemblies may be used are disclosed in Pub. No. US 2014/0071276, which is incorporated by reference in its entirety.

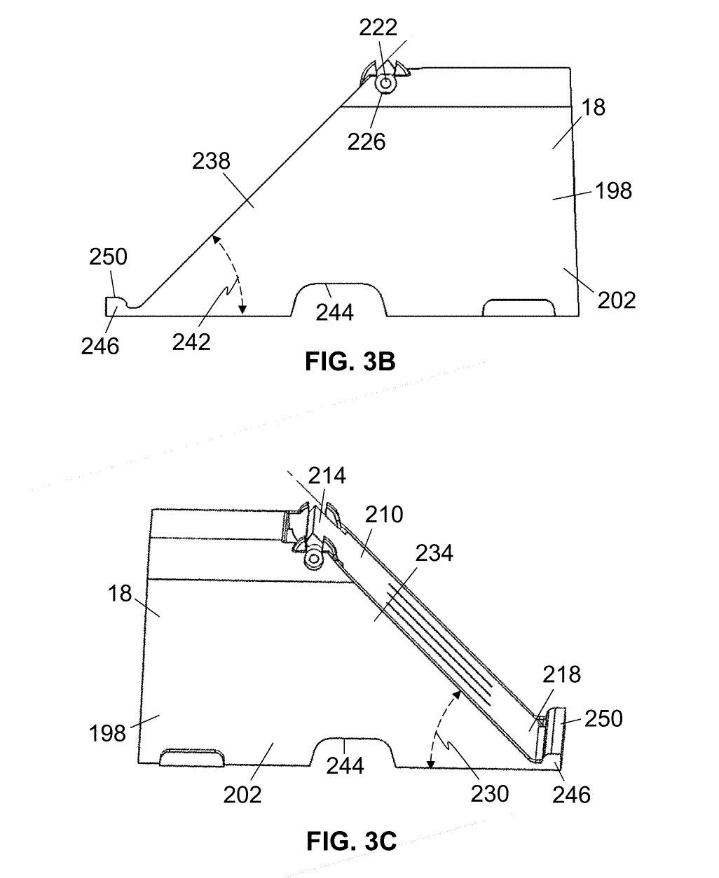

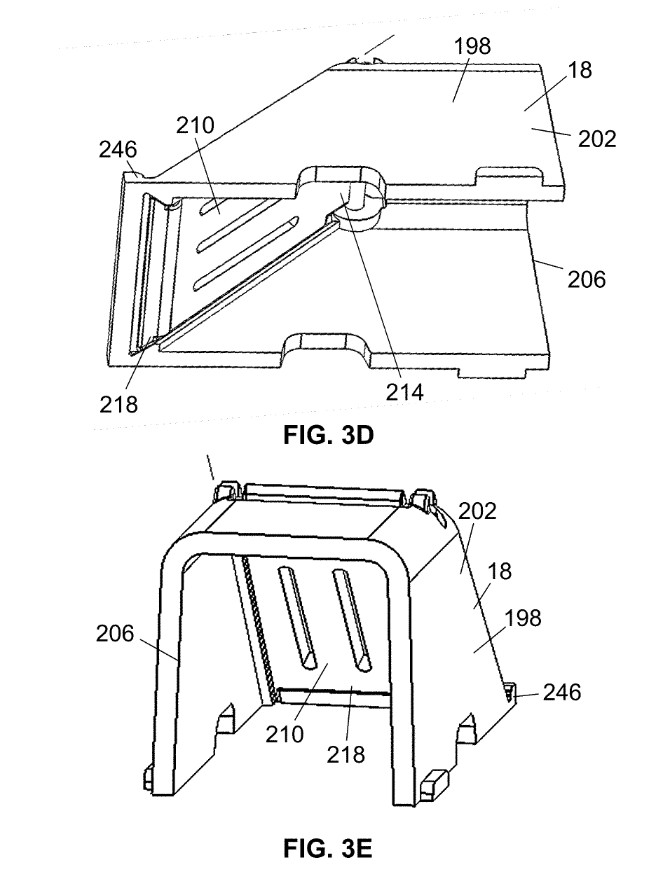

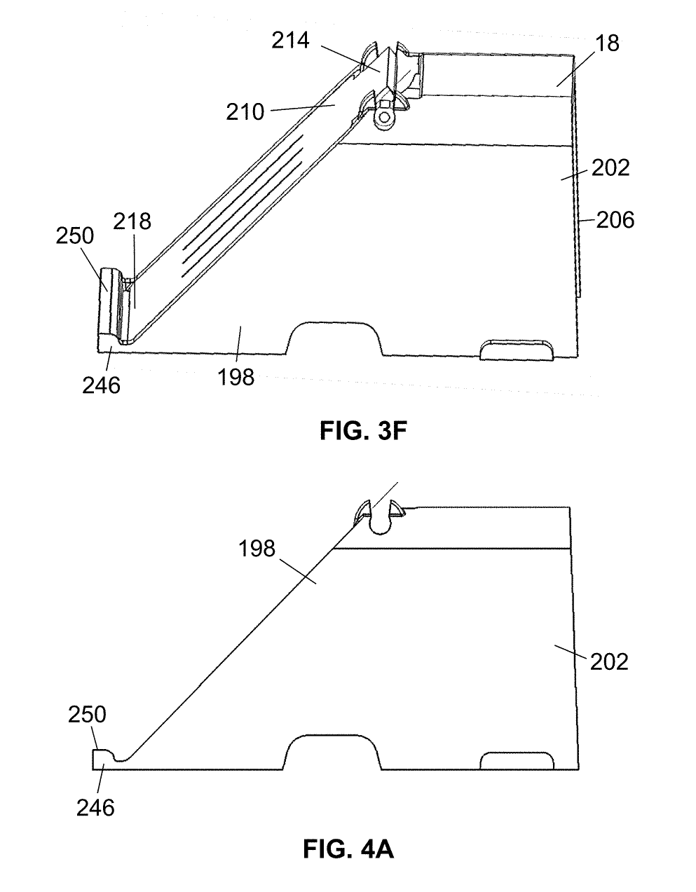

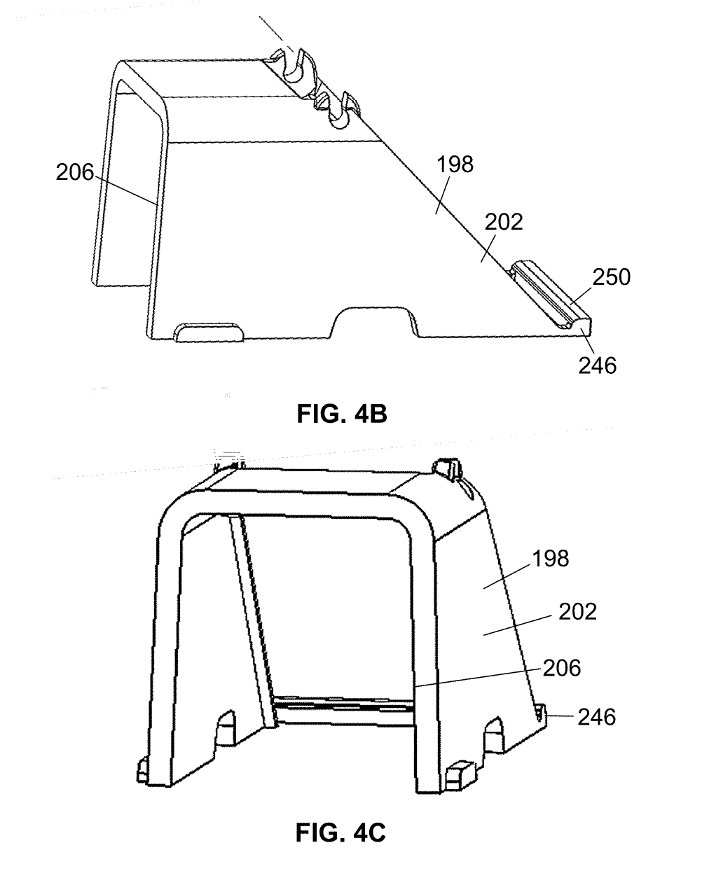

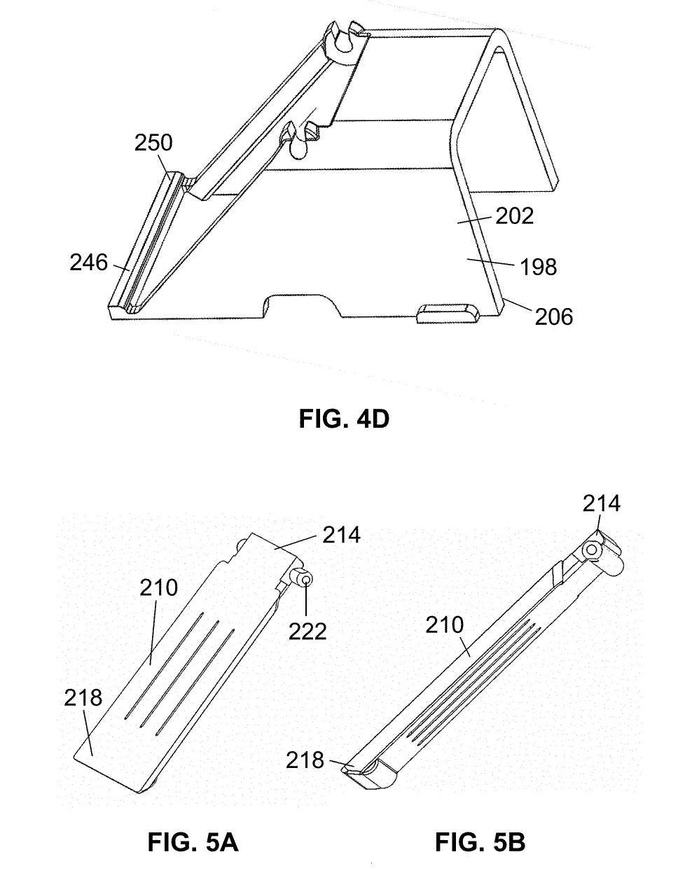

Referring additionally to FIGS. 3A-3F, 4A-4D, 5A and 5B, shown are an entrance assembly 18 and related components, which may be suitable for use in some embodiments of the present pest-management assemblies. For example, in the embodiment shown, assembly 10a comprises one or more entrance assemblies 18 (e.g., two entrance assemblies, as shown) that are configured to be coupled to capture station 14 to control pest ingress to and/or egress from an interior of the capture station when lid 26 is in the closed position. In this embodiment, each entrance assembly 18 comprises an entranceway 198 including a sidewall 202 defining an opening 206 through which a pest can enter capture station 14 when the entrance assembly is coupled to the capture station. For example, in the depicted embodiment, each entranceway 198 is configured to be coupled to capture station 14 (e.g., at base 22, lid 26, and/or the like) such that opening 206 of the entranceway is in communication with one of entrance opening(s) 66 defined by the capture station. For example, in this embodiment, each entranceway 198 is configured to be coupled to capture station 14 via one or more interlocking features of the entranceway and the capture station, such as, for example, clips 204 (FIG. 3A) of base 22 that each may be configured to receive a portion of the entranceway (e.g., lip 246, sidewall 202 or a protrusion thereof, and/or the like) to secure the entranceway relative to the capture station; however, in other embodiments, an entranceway (e.g., 198) of a respective entrance assembly (e.g., 18) may be coupled to a respective capture station (e.g., 14) in any suitable fashion, such as, for example, via fasteners, integral formation with a base 22, lid 26, and/or the like of the respective capture station, and/or the like.

In the embodiment shown, each entrance assembly 18 comprises a door 210 having a first end 214 and a second end 218. In this embodiment, first end 214 of each door 210 is configured to be pivotally coupled to a respective entranceway 198 such that the door is movable between a closed position, in which, when the respective entranceway is coupled to capture station 14, the door obstructs a passage between an interior of the capture station and opening 206 of the respective entranceway, and an open position. For example, in the depicted embodiment, first end 214 of each door 210 defines one or more protrusions 222, each configured to be rotatably received by a respective recess 226 of a respective entranceway 198 such that the door may pivot relative to the respective entranceway on the one or more protrusions within the respective recesses. However, in other embodiments, a door (e.g., 210) of a respective entrance assembly (e.g., 18) may be coupled to an entranceway (e.g., 198) of the respective entrance assembly in any suitable fashion (e.g., that provides for a pivotal or hinged connection between the door and the entranceway). For example, in these other embodiments, a door (e.g., 210) may be unitary with an entranceway (e.g., 198) and pivotal via a living hinge.

In the embodiment shown, for each entrance assembly 18, door 210 is configured to be biased towards the closed position (e.g., biased by a weight of the door, one or more springs disposed between the door and entranceway 198, and/or the like). For example, in this embodiment, for each entrance assembly 18, when the entrance assembly is coupled to capture station 14 and door 210 is in the closed position, the door extends from floor 138 at a non-perpendicular angle 230 (FIG. 3C) (e.g., from 40 to 50 degrees, such as, for example, 45 degrees) (e.g., such that a weight of the door acts to urge the door towards the closed position). In these ways and others, a pest (e.g., rodent) exterior to capture station 14 may gain access to an interior of the capture station by exerting a force on a door 210 to move the door from the closed position towards the open position, and once the pest is clear of the door, the door may return to the closed position (e.g., thereby capturing the pest in the interior of the capture station).

In the depicted embodiment, each entranceway 198 is configured to physically prevent a respective door 210 from moving beyond the closed position (e.g., in a direction away from the open position). For example, in the embodiment shown, each entranceway 198 comprises a first side 234 and a second side 238 (e.g., through which a pest can enter capture station 14), and a respective door 210, when in the closed position, is adjacent to the first and second sides such that at least a portion of the first side and/or at least a portion of the second side physically prevents passage of at least a portion of the respective door between the first and second sides. To illustrate, in this embodiment, for each entranceway 198, a portion of first side 234 and a portion of second side 238 each extend away from floor 138 at an non-perpendicular angle 242 (FIG. 3B), which may be substantially equal to angle 230.

In the depicted embodiment, first side 234 and/or second side 238 of each entrance assembly 18 defines one or more openings 244 through the first side and/or second side, each of the one or more openings disposed between opening 206 and door 210. In the embodiment shown, each of one or more openings 244 of each entrance assembly 18 is in communication with an interior of capture station 14 when the entrance assembly is coupled to the capture station, and each of the one or more openings is sized to accommodate relatively small pests (e.g., smaller than a rodent), such as, for example, insects, spiders, and/or the like. In these ways and others, each entrance assembly 18 may be configured to allow smaller pests to enter capture station 14 by bypassing door 210 (e.g., as such smaller pests may be incapable of moving the door from the closed position to the open position).

In this embodiment, entranceway 198 of each entrance assembly 18 comprises a lip 246 positioned such that the lip is interior to capture station 14 when the entranceway is coupled to the capture station. In the depicted embodiment, each lip 246 is configured to prevent a pest within capture station 14 from engaging second end 218 of a respective door 210 (e.g., to prevent a pest within the capture station from moving the respective door from the closed position towards the open position). For example, in the embodiment shown, lip 246 of each entranceway 198 has an upper edge 250 that is disposed farther from floor 138 than is second end 218 of door 210 when the entranceway is coupled to capture station 14 and the door is in the closed position (e.g., such that access to at least a portion of the second end of the door from an interior of capture station 14 is obstructed by the lip). In this embodiment, each lip 246 is positioned such that the lip does not obstruct a respective door 210 itself from moving between the closed position and the open position. For example, in the depicted embodiment, each lip 246 is spaced apart from an arcuate path defined by second end 218 of a respective door 210 when the door is moved between the closed position and the open position.

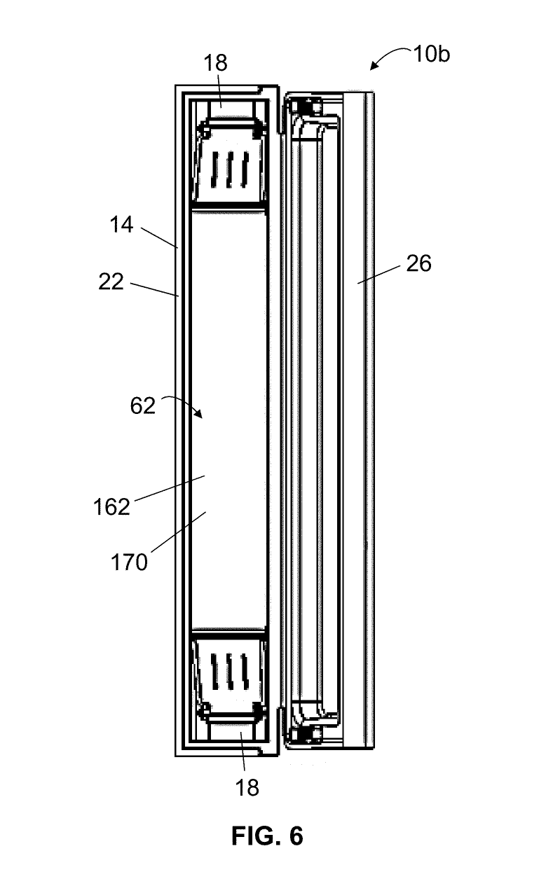

Referring now to FIG. 6, shown is a second embodiment 10b of the present pest-management assemblies. Assembly 10b may be substantially similar to assembly 10a, with the primary exception that a majority of (e.g., up to and including all of) chamber 62 of assembly 10b comprises an entry portion 162 (e.g., defining an elongated tunnel 170 having a length that is 2, 2.5, 3, 3.5, 4, or more times a corresponding length of an entrance assembly 18). As described above, entrance assembl(ies) 18 may permit a pest, such as a rodent, to enter an interior of capture station 14, but may prevent the pest from exiting the interior of the capture station, and thus, in some embodiments (e.g., 10b), a separate rodent capture portion(s) (e.g., 158) with capture means (e.g., such as glue or adhesive board 174, snap trap(s), poisons, and/or the like) may be omitted. In this embodiment, portions of entrance assemblies 18 may be unitary with base 18 (e.g., sidewall 198 may be unitary with base 18 such that assembly 10b comprises as few as three parts: base 18 and two doors 210). Other embodiments of assembly 10b may include only a single door.

The above specification and examples provide a complete description of the structure and use of illustrative embodiments. Although certain embodiments have been described above with a certain degree of particularity, or with reference to one or more individual embodiments, those skilled in the art could make numerous alterations to the disclosed embodiments without departing from the scope of this invention. As such, the various illustrative embodiments of the methods and systems are not intended to be limited to the particular forms disclosed. Rather, they include all modifications and alternatives falling within the scope of the claims, and embodiments other than the one shown may include some or all of the features of the depicted embodiment. For example, elements may be omitted or combined as a unitary structure, and/or connections may be substituted. Further, where appropriate, aspects of any of the examples described above may be combined with aspects of any of the other examples described to form further examples having comparable or different properties and/or functions, and addressing the same or different problems. Similarly, it will be understood that the benefits and advantages described above may relate to one embodiment or may relate to several embodiments.

The claims are not intended to include, and should not be interpreted to include, means-plus- or step-plus-function limitations, unless such a limitation is explicitly recited in a given claim using the phrase(s) “means for” or “step for,” respectively.

1. A pest-management assembly comprising:
a capture station; and
an entrance assembly comprising:
a door having a first end and a second end; and
an entranceway comprising:
a sidewall defining an opening through which a pest can enter the capture station; and
a lip positioned such that it is interior to the capture station;
where the first end of the door is pivotally coupled to the entranceway such that the door is movable between:
a closed configuration in which the door is positioned adjacent to the sidewall, and the door extends away from a floor of the pest-management assembly at an angle; and
an open configuration;
where the lip of the entranceway has an upper edge disposed farther from a floor of the pest-management assembly than the second end of the door when the door is in the closed configuration, the lip positioned such that the lip does not obstruct the door from moving to the open configuration.

2. The pest-management assembly of claim 1, where the entrance assembly is coupled to the capture station.

3. The pest-management assembly of claim 1, where the capture station defines an elongated tunnel sized to accommodate a pest.

4. The pest-management assembly of claim 1, where the entrance assembly is a first entrance assembly, and the pest-management assembly further comprises a second entrance assembly comprising:
a door having a first end and a second end; and
an entranceway comprising:
a sidewall defining an opening through which a pest can enter the capture station; and
a lip positioned such that it is interior to the capture station;
where the first end of the door is pivotally coupled to the entranceway such that the door is movable between:
a closed configuration in which the door is positioned adjacent to the sidewall, and the door extends away from a floor of the pest-management assembly at an angle; and
an open configuration;
where the lip of the second entrance assembly has an upper edge disposed farther from a floor of the pest-management assembly than the second end of the door when the door is in the closed configuration, the lip positioned such that the lip does not obstruct the door from moving to the open configuration.

5. The pest-management assembly of claim 4, where the second entrance assembly is coupled to the capture station.

6. The pest-management assembly of claim 1, where the capture station comprises:
a lid configured to be coupled to a base such that the base and the lid cooperate to define a chamber, where at least one of the base and the lid comprises a sidewall at least partially defining an external perimeter of the assembly;
where at least one of the base, the lid, and the sidewall is configured to be coupled to the entrance assembly.

7. The pest-management assembly of claim 1, where the lip of entranceway is configured to prevent a pest in the capture station from engaging the second end of the door.

8. The pest-management assembly of claim 1, where the angle at which a door extends away from a floor of the pest-management assembly comprises from 40 to 50 degrees.

9. The pest management assembly of claim 1, where the sidewall comprises:
a first side and a second side through which a pest can enter the capture station, where a portion of the first side and a portion of the second side extend away from a floor of the pest-management assembly at an angle, and where the door is positioned adjacent to the portion of the first side and the portion of the second side that extend away from a floor of the pest-management assembly at an angle such that the door extends away from a floor of the pest-management assembly at substantially the same angle.

10. A pest-management assembly comprising:
a base; and
a lid configured to be coupled to the base such that the base and the lid cooperate to define a chamber, where at least one of the base and the lid comprises a sidewall at least partially defining an external perimeter of the assembly;
where at least one of the base, the lid, and the sidewall is configured to be coupled to an entrance assembly that comprises:
a door having a first end and a second end; and
an entranceway comprising:
a sidewall defining an opening through which a pest can enter the chamber; and
a lip positioned such that it is interior to the chamber, if the entrance assembly is coupled to at least one of the base, the lid, and the sidewall;
where the first end of the door is pivotally coupled to the entranceway such that the door is movable between:
a closed configuration in which the door is positioned adjacent to the sidewall, and the door extends away from the base at an angle; and
an open configuration;
where the lip of the entranceway has an upper edge disposed farther from the base of the pest-management assembly than the second end of the door when the door is in the closed configuration, the lip positioned such that the lip does not obstruct the door from moving to the open configuration.

11. The pest-management assembly of claim 10, further comprising:
an entrance assembly coupled to at least one of the base, the lid, and the sidewall, where the entrance assembly comprises:
a door having a first end and a second end; and
an entranceway comprising:
a sidewall defining an opening through which a pest can enter the chamber; and
a lip positioned such that it is interior to the chamber;
where the first end of the door is pivotally coupled to the entranceway such that the door is movable between:
a closed configuration in which the door is positioned adjacent to the sidewall, and the door extends away from the base at an angle; and
an open configuration;
where the lip of the entranceway has an upper edge disposed farther from the base of the pest-management assembly than the second end of the door when the door is in the closed configuration, the lip positioned such that the lip does not obstruct the door from moving to the open configuration.

12. The pest-management assembly of claim 10, where at least one of the base, the lid, and the sidewall is further configured to be coupled to another entrance assembly that comprises:
a door having a first end and a second end; and
an entranceway comprising:
a sidewall defining an opening through which a pest can enter the chamber; and
a lip positioned such that it is interior to the chamber, if the another entrance assembly is coupled to at least one of the base, the lid, and the sidewall;
where the first end of the door is pivotally coupled to the entranceway such that the door is movable between:
a closed configuration in which the door is positioned adjacent to the sidewall, and the door extends away from the base at an angle; and
an open configuration;
where the lip of the entranceway has an upper edge disposed farther from the base of the pest-management assembly than the second end of the door when the door is in the closed configuration, the lip positioned such that the lip does not obstruct the door from moving to the open configuration.

13. The pest-management assembly of claim 11, where the entrance assembly is a first entrance assembly, and the pest-management assembly further comprises:
a second entrance assembly coupled to at least one of the base, the lid, and the sidewall, where the second entrance assembly comprises:
a door having a first end and a second end; and
an entranceway comprising:
a sidewall defining an opening through which a pest can enter the chamber; and
a lip positioned such that it is interior to the chamber;
where the first end of the door is pivotally coupled to the entranceway such that the door is movable between:
a closed configuration in which the door is positioned adjacent to the sidewall, and the door extends away from the base at an angle; and
an open configuration;
where the lip of the entranceway has an upper edge disposed farther from the base of the pest-management assembly than the second end of the door when the door is in the closed configuration, the lip positioned such that the lip does not obstruct the door from moving to the open configuration.

14. The pest-management assembly of claim 11, where the lip of the entranceway is configured to prevent a pest in the chamber from engaging the second end of the door.

15. The pest-management assembly of claim 10, where the angle at which a door extends away from the base comprises from 40 to 50 degrees.

16. The pest management assembly of claim 10, where the sidewall comprises:
a first side and a second side through which a pest can enter the chamber, where a portion of the first side and a portion of the second side extend away from the base of the pest-management assembly at an angle, and where the door is positioned adjacent to the portion of the first side and the portion of the second side that extend away from the base of the pest-management assembly at an angle such that the door extends away from the base of the pest-management assembly at substantially the same angle.

17. An entrance assembly configured to be coupled to a capture station, the entrance assembly comprising:
a door having a first end and a second end; and
an entranceway comprising:
a sidewall through which a pest can move; and
a lip positioned such that it is interior to a capture station, if the entrance assembly is coupled to a capture station;
where the first end of the door is configured to be pivotally coupled to the entranceway such that the door is movable between:
a closed configuration in which the door is positioned adjacent to the sidewall, and the door extends away from a floor of a capture station at an angle, if the entrance assembly is coupled to a capture station; and
an open configuration;
where the lip of the entranceway has an upper edge disposed farther from a floor of the capture station than the second end of the door when the door is in the closed configuration, if the entrance assembly is coupled to a capture station, the lip positioned such that the lip does not obstruct the door from moving to the open configuration.

18. The entrance assembly of claim 17, where the entrance assembly is coupled to a capture station.

19. The entrance assembly of claim 18, where the capture station defines an elongated tunnel sized to accommodate a pest.

20. The entrance assembly of claim 17, where the lip of the entranceway is configured to prevent a pest in a capture station from engaging the second end of the door, if the entrance assembly is coupled to a capture station.

21. The entrance assembly of claim 17, where the angle at which the door extends away from a floor of a capture station comprises from 40 to 50 degrees.

22. The entrance assembly of claim 17, where the first end of the door is pivotally coupled to the entranceway.

23. The entrance assembly of claim 17, where the sidewall comprises:
a first side and a second side, where a portion of the first side and a portion of the second side extend away from a floor of a capture station, if the entrance assembly is coupled to a capture station, where the door is positioned adjacent to the portion of the first side and the portion of the second side that extend away from a floor of a capture station at an angle such that the door extends away from a floor of the capture station at substantially the same angle.
